(19) United States
(12) Patent Application Publication
(10) Pub. No.: US 2026/0266410 A1
(43) Pub. Date: Sep. 10, 2026

(54) HOSE CONTAINMENT SYSTEM

(71) Applicant: FLX Energy Services, Inc., Floresville, TX (US)

(72) Inventor: Michael G. Rylee, Odessa, TX (US)

(21) Appl. No.: 19/555,780

(22) Filed: Mar. 3, 2026

Related U.S. Application Data
(60) Provisional application No. 63/767,255, filed on Mar. 5, 2025.

(51) Int. Cl. F16L 55/00; E21B 43/26; E21B 41/00

(52) U.S. Cl. CPC F16L 55/005; E21B 43/2607; E21B 41/0021

(57) ABSTRACT

A modular hose restraint system for high-pressure frac hoses in hydraulic fracturing operations includes interconnected pipe segments forming an exoskeleton with inner and outer flexible piping sleeves, flanged ends for bolting, lifting eyes, anchoring shackles, and restraint cables. The system may offer full-length containment, controlled fluid discharge, easy installation and repair, and elevation of the hose from the ground.

### CROSS REFERENCE TO RELATED APPLICATIONS

The present application claims priority to and the benefit of U.S. Provisional Patent Application Ser. No. 63/767,255, filed Mar. 5, 2025, and is incorporated herein by reference in its entirety.

### TECHNICAL FIELD

The present disclosure pertains generally to hose containment systems, and more particularly to a modular containment and/or restraint system for frac hoses used in hydraulic fracturing operations.

### BACKGROUND

This section of this document introduces information about and/or from the art that may provide context for or be related to the subject matter described herein and/or claimed below. It provides background information to facilitate a better understanding of the various aspects of the present invention. This is a discussion of “related” art. That such art is related in no way implies that it is also “prior” art. The related art may or may not be prior art. The discussion in this section of this document is to be read in this light, and not as admissions of prior art.

Hydraulic fracturing operations in oil and gas extraction involve high-pressure frac hoses that transport abrasive fracturing fluids at pressures exceeding 10,000–15,000 psi, posing significant risks of rupture due to factors like pressure surges, material fatigue, improper connections, or inadequate maintenance. Such ruptures can cause violent hose whipping, high-velocity fluid ejection, and exposure to toxic chemicals, leading to severe injuries including blunt trauma, high-pressure injection wounds, chemical burns, infections, and even fatalities, as well as environmental hazards like spills and fires. Industry safety alerts underscore the need for enhanced protective measures to safeguard workers and sites.

Prior attempts to mitigate these risks, such as basic whip checks, safety cables, or sock-like restraints, provide limited containment and often fail to adequately distribute forces, contain fluid releases, or accommodate the dynamic movements inherent in frac setups. There remains a critical need for an advanced, modular hose containment system that offers layered protection, robust restraint, and operational flexibility to prevent catastrophic failures without compromising efficiency.

### SUMMARY

The present disclosure addresses the aforementioned needs by providing a hose containment system, referred to hereafter as a hose restraint system or exoskeleton, designed to mitigate the risks associated with high-pressure frac hose failures in hydraulic fracturing operations.

In a first aspect, an example embodiment is directed a system that comprises a plurality of pipe segments configured for containing a high-pressure frac hose in hydraulic fracturing operations. Each pipe segment may include an inner flexible piping sleeve and an outer piping sleeve surrounding the inner flexible piping sleeve. The plurality of pipe segments are interconnectable to form an exoskeleton encasing the frac hose along its length. The assembled exoskeleton may be securable between a pump truck providing a high pressure fluid source for the frac hose and a frame of a manifold or missile.

In a second aspect, an example embodiment is directed to a pipe segment comprising an inner flexible piping sleeve configured to encase a portion of a frac hose and an outer piping sleeve surrounding the inner flexible piping sleeve. The pipe segment may be configured for a modular hose restraint system in high-pressure fluid operations and may be interconnectable with other like pipe segments to form an exoskeleton providing full-length containment of the frac hose.

In a third aspect, an example embodiment is directed to a method of containing a high-pressure frac hose using the aforementioned system. In the method, each pipe segment over a portion of the frac hose and bolted to adjacent pipe segments together to assemble the exoskeleton. The assembled exoskeleton is then secured between a pump truck and a frame of a manifold or missile. With the exoskeleton in place for fracking operations, the frac hose may then be operated within the assembled exoskeleton.

The above presents a simplified summary of the invention as claimed below in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The foregoing summary, as well as the following detailed description of illustrative embodiments, is better understood when read in conjunction with the appended drawings. Other aspects, features, and advantages of described embodiments will become more fully apparent from the following detailed description, the appended claims, and the accompanying drawings in which like reference numerals identify similar or identical elements. For the purpose of illustrating the embodiments, there is shown in the drawings example constructions of the embodiments; however, the embodiments are not limited to the specific methods and instrumentalities disclosed. In the drawings:

FIG. 1 is a side elevational view of the hose restraint system in an assembled configuration, showing multiple pipe segments connected between a manifold/missile and a pump truck, with restraint cables and associated components;

FIG. 2 is a side elevational view of a single pipe segment of the hose restraint system, illustrating the outer flexible piping sleeve, pipe flange ends, lifting eye, and anchoring shackle;

FIG. 3 is an end view of a pipe segment, depicting the concentric arrangement of the inner flexible piping sleeve, outer flexible piping sleeve, pipe flange end with bolt holes, and the enclosed frac hose; and

FIG. 4 is a graph of break testing (or pull testing) conducted for the exoskeleton of the example system.

While the disclosed subject matter is susceptible to various modifications and alternative forms, the drawings illustrate specific implementations described in detail by way of example. It should be understood, however, that the description herein of specific examples is not intended to limit that which is claimed to the particular forms disclosed, but on the contrary, the intention is to cover all modifications, equivalents, and alternatives falling within the spirit and scope of the appended claims.

### DETAILED DESCRIPTION

A typical fracking operation involves an array of equipment, including high-pressure pumps, blenders, fluid storage tanks, and extensive surface piping and hoses. These components deliver the fracturing fluid downhole at pressures often exceeding 10,000 to 15,000 psi. The frac hose, also referred to as a fracturing hose or a high-pressure frac hose, functions as a critical flexible conduit in a fracking operation. It transports the high-pressure fracturing fluid—comprising water blended with proppants and chemicals—from pumping equipment, such as triplex or quintuplex pumps, (e.g., reciprocating positive displacement pumps featuring 3 or 5 pistons driven by separate drive rods to handle high pressures while providing smoother fluid flow; commonly used in industrial applications where high flow rates and minimal pressure pulsations are critical) to the wellhead.

Frac hoses are heavy-duty and reinforced with multiple layers of steel wire or synthetic materials to endure extreme pressures, abrasion from proppants, vibration, and corrosive chemicals. They offer flexibility in connecting mobile pump trucks to rigid iron piping or the wellhead, accommodating uneven terrain and simplifying rig-up procedures. By minimizing rigid connections prone to failure under stress, frac hoses facilitate the bulk transfer of abrasive, high-volume slurries while helping to contain fluids and prevent spills during pumping.

However, frac hose ruptures represent a severe hazard. Such failures can arise from various causes, including exceeding the hose's pressure rating due to pump surges or blockages, material fatigue from repeated high-pressure cycles and proppant abrasion, improper assembly or mismatched connections (e.g., hammer unions), external damage such as cuts or kinks, extreme temperatures that weaken the hose structure, or inadequate maintenance and inspection. Upon rupture, the hose may whip violently under residual pressure, expelling a high-velocity stream of fluid, sand, and chemicals.

The risks to operators and workers can be profound. The whipping hose can inflict blunt force trauma, crush injuries, or amputations. High-pressure fluid injection can penetrate skin, causing tissue necrosis, chemical burns, infections, or necessitating amputation if not promptly treated. Exposure to toxic frac fluid components—such as acids, biocides, or friction reducers—may lead to poisoning, respiratory distress, or chronic health issues. Sudden releases can also generate slip hazards from spilled fluids, ignition risks if flammable elements are present, or environmental contamination. Industry incident reports and safety advisories document fatalities and serious injuries attributable to frac hose failures, emphasizing the imperative for enhanced pressure monitoring, equipment inspections, and exclusion zones.

The above-noted prior solutions such as whip socks or restraints limited to hose couplings merely offer very limited and partial protection. These solutions do not even address full-length hose body failures. Additionally, these systems often lack modularity, making repairs cumbersome and downtime costly, and fail to incorporate any kind of controlled discharge mechanisms to redirect escaping fluids and energy. The prior system further do not elevate the frac hose to protect it against ground contact and environmental exposure.

In light of the above issues, and as to be described in more detail hereafter, the present disclosure offers one or more embodiments directed to a hose containment system, also referred to occasionally herein as a hose restraint system or exoskeleton. The system may represent a markedly-improved safety system for high-pressure fluid conduits in industrial operations, particularly as a modular containment and restraint system for frac hoses used in hydraulic fracturing operations in the oil and gas industry, mitigating risks associated with high-pressure frac hose failures therein.

In some embodiments to be described more fully hereafter, the system may comprise a plurality of interconnected pipe segments forming a modular exoskeleton that encases the entire length of a frac hose, providing 360-degree containment and restraint. In some embodiments, each pipe segment may include an inner flexible piping sleeve and an outer flexible piping sleeve, with the outer sleeve braided for enhanced strength and flexibility. The sleeves terminate at opposite ends with circular or beveled pipe flange ends equipped with spaced bolt holes for secure bolting to adjacent segments using high-strength bolt, washer, and nut sets. Lifting eyes, formed via eyehooks welded to the flange ends, facilitate handling and transport. Anchoring shackles connect to these lifting eyes, allowing attachment of restraint cables that secure the system to fixed points such as a pump truck and a manifold or missile frame.

According to some embodiments described in more detail hereafter, the system's modular flanged design may enable rapid field replacement of damaged sections, minimizing downtime and maintenance costs. The disclosed system may elevate an enclosed frac hose above the ground, shielding it from environmental elements. System installation may be highly efficient, requiring approximately 15-20 minutes with two personnel, and the system can remain assembled during transport.

On some embodiments, the system may provide full-length containment to shield against frac hose body failures, and may incorporate controlled discharge subsystem that redirects fluid, sand, and pressure energy through an internal annular pathway to reduce whipping and injury risks. High-tensile materials such as T321 and T304 stainless steel may be used for the sleeves and schedule 40 carbon alloy steel for the flanges. Restraint cables and shackles included in the system may be rated for substantial loads, ensuring robust anchoring. In some embodiments, the example system may offer enhanced worker safety, reduced environmental impact, operational efficiency, and cost savings through modularity and durability, advantages not available in conventional safety systems for frac hoses.

Turning now to the drawings, illustrative examples of the subject matter claimed below are disclosed. In the interest of clarity, not all features of an actual implementation are described for every example in this specification. It will be appreciated that in the development of any such actual implementation, numerous implementation-specific decisions may be made to achieve the developers’ specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

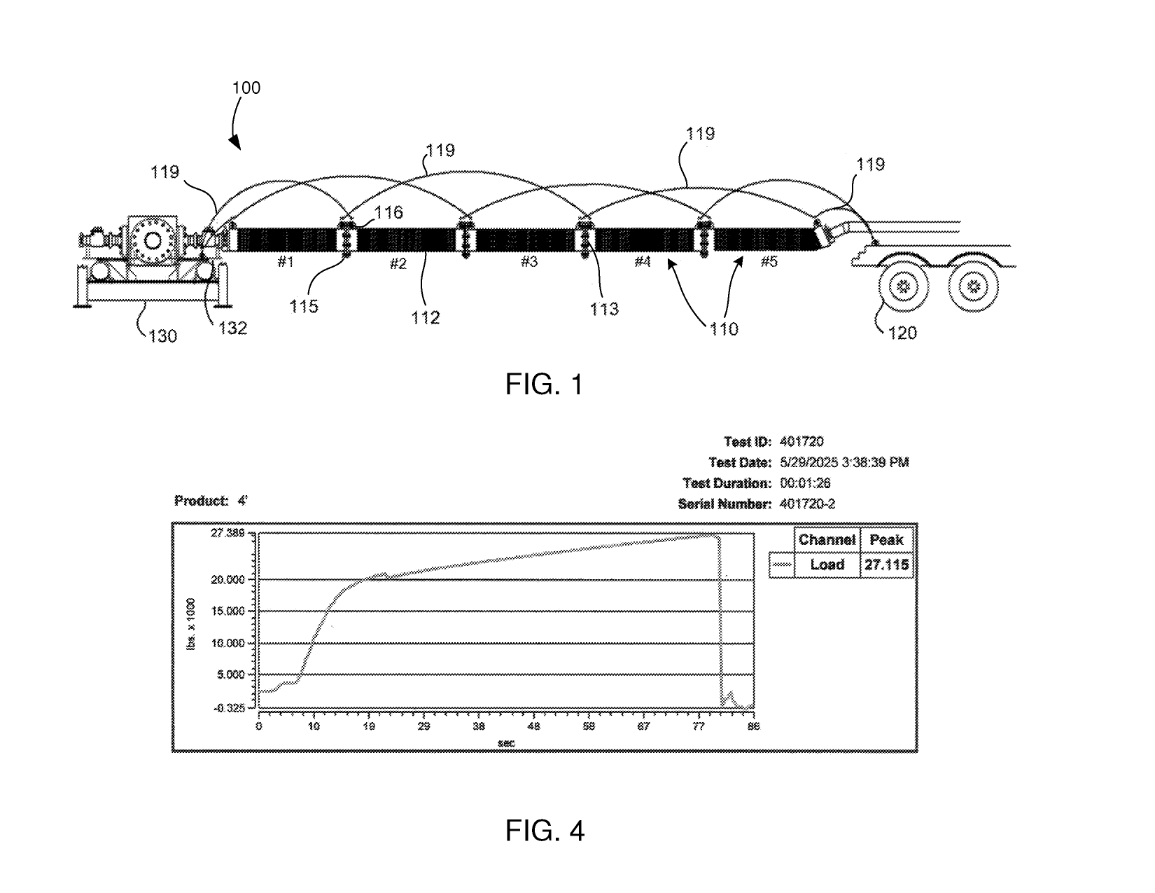

Referring to FIG. 1, a hose restraint system 100 is shown in an exemplary configuration comprising a plurality of pipe segments 110 (in this example five segments are shown for exemplary purposes only) interconnected to form a continuous exoskeleton encasing a frac hose 105. The system 100 extends between a pump truck 120, serving as the source of high-pressure fluid, and a manifold or missile 130, which may include a frame 132 for anchoring. The frac hose 105 is threaded through the interior bores of the pipe segments 110 in system 100, with its ends connected to the pump truck 120 and manifold/missile 130 respectively via standard fittings (not shown).

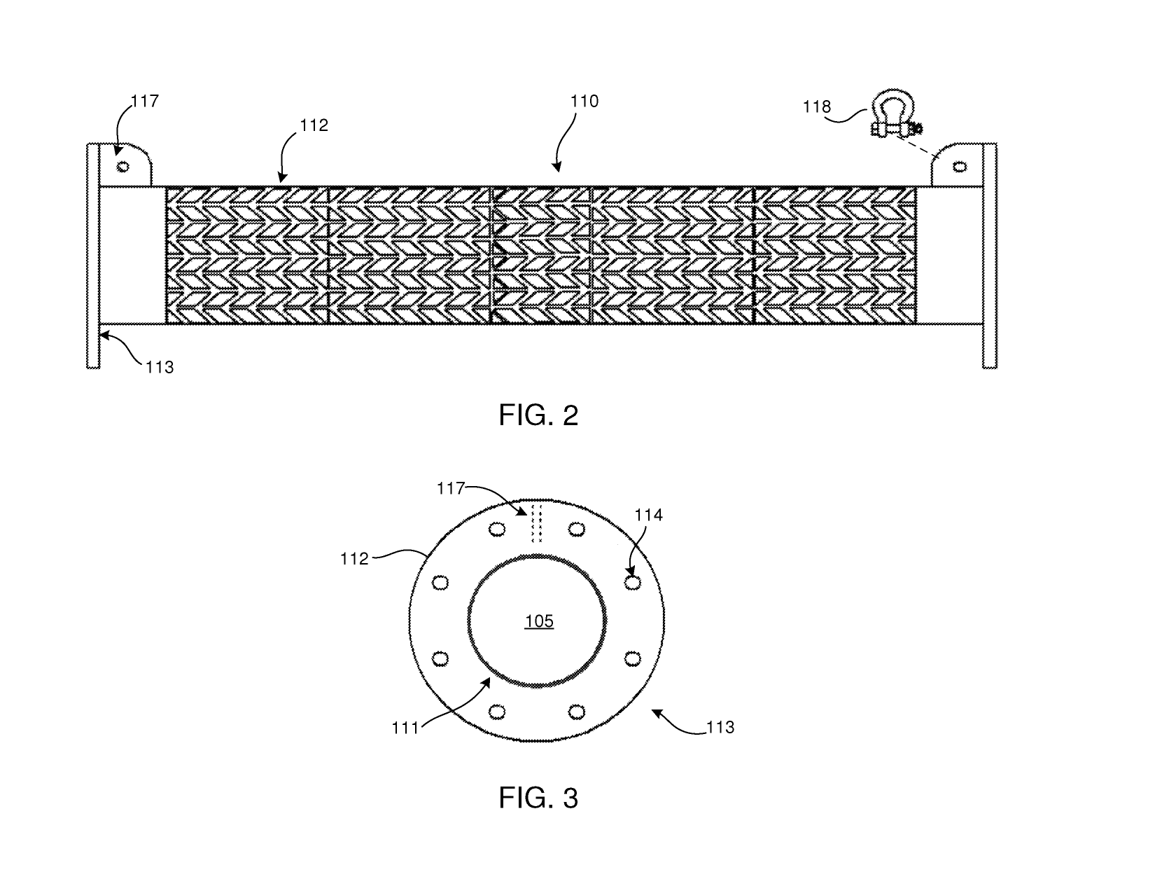

Each pipe segment 110, as detailed in FIGS. 2 and 3, comprises an inner flexible piping sleeve 111 and an outer flexible piping sleeve 112. The inner sleeve 111 may provide a primary containment layer, while the outer sleeve 112, which in some embodiments may be braided, offers additional structural integrity and abrasion resistance. In some embodiments, one or both sleeves 111 and 112 may be constructed from T321 stainless steel, T304 stainless steel, or combinations thereof, yielding a tensile strength of approximately 27,115 psi (as certified). Alternative materials for the sleeves 111 and/or 112 may include Kevlar, braided nylon, braided rubber, or brass, selected based on specific operational requirements such as flexibility, corrosion resistance, and cost.

The sleeves 111 and 112 terminate at opposite ends with circular or beveled pipe flange ends 113, which may be formed from schedule 40 carbon alloy steel having a tensile strength of 60,000 psi. Each flange end 113 includes a plurality of spaced bolt holes 114 arranged around its circumference, typically eight holes per flange for robust connection. Adjacent pipe segments 110 are joined by aligning facing flange ends 113 and securing them with bolt, washer, and nut sets 115. In an example, the bolts in may be embodied as grade 8 bolts torqued to 380 lb./ft, each with a tensile strength of 150,000 psi. This bolting arrangement may impart an overall tensile strength of 60,000 psi to the connected flange ends 113.

Integrated into each flange end 113 is an eyehook 116, e.g., welded thereto, forming a lifting eye 117. The eyehook 116 may be constructed from materials matching the flange's tensile strength of 60,000 psi. The lifting eyes 117 enable safe handling, lifting, and transport of individual segments 110 or the assembled system 100 using machinery or manual methods.

Anchoring shackles 118, which in some constructions may be rated at a 4.75-ton working load limit with a 3:1 safety factor (maximum load of 28,500 psi), are connectable to the lifting eyes 117. A cabling system comprising a plurality of restraint cables 119 attach to the shackles 118. In some constructions, the restraint cables 119 may be embodied as 1-inch diameter wire whipchecks that are rated at a 2.5-ton working load limit with a 5:1 safety factor (maximum load of 25,000 psi). In the assembled system 100, the restraint cables 119 secure the terminal pipe segments 110 to the pump truck 120 and the frame 132 of the manifold/missile 130. In some constructions, the terminal ends are double-cabled for added redundancy.

The restraint cables 119 serve a few purposes. Without the cabling system shown in FIG. 1, a forklift operator would typically insert their times underneath the frac hose 105, often inadvertently tearing it or damaging it in the process. The cabling system offers a separate grab point for the forklift operator to lift the entire assembled system 100 with frac hose 105 from the top, avoiding potential damage. Secondly, the cabling system of cables 119 serves as backup protection around the frac hose 105 should the flange ends 113 start to fail. As they are connected across and between the various segments 110 between the pump truck 120 and the missile 130, the cables 119 may maintain the segments 110 in connective engagement together if s failure at the flange ends 113 occur.

The system's 100 design provides 360-degree full-length containment, shielding the entire hose body of the frac hose 105 and mitigating failure scenarios beyond mere couplings. Upon a frac hose 105 rupture, the controlled discharge system redirects fluid, sand, and pressure energy through the annular pathway between the inner sleeve 111 and the frac hose 105, and potentially between the sleeves 111 and 112, thereby reducing whipping action and directing discharge away from personnel.

The modular flanged design for system 100 allows for quick replacement of damaged pipe segments 110 in the field, reducing downtime. The elevated structure prevents the frac hose 105 from contacting the ground, protecting it from abrasion and environmental elements such as weather, debris, or contaminants.

Installation of the system 100 can occur at the operator's yard or on-site. In the example of FIG. 1, the length of each pipe segment may be 54 inches, although other lengths and dimensions are contemplated herein. Each 54-inch segment 110 slides over the frac hose 105 sequentially, with end clamps (not shown) applied to the frac hose 105 ends to prevent slippage. The assembled system 100, weighing approximately 250 pounds (lb.) when rigged, is configured to remain intact during transport, either mounted on the pump truck 120, or lifted via the lifting eyes 117. Two personnel can install the system in 15-20 minutes, streamlining workflow and enhancing safety.

In operation, the system 100 contains and restrains the frac hose 105 under pressures exceeding 10,000 psi, preventing catastrophic releases and associated hazards. The combination of high-strength materials, modular assembly, and anchoring features ensures reliability in demanding frac environments.

FIG. 4 is a graph 400 of break testing (or pull testing) conducted for the exoskeleton of system 100, in which a standalone 4’ sample of pipe segment 110 was stress-tested over approximately 90 seconds. The sample was made up of T321 and T304 stainless steel for the outer and inner sleeves, with the flanges 113 made up of carbon alloy steel, specifically schedule 40 steel. The graph reveals the extremely high tensile strength of the pipe segment sample, achieving a peak tensile strength of 27,115 ft-lb before failure.

Variations contemplated in system 100 may include but are not limited to different segment lengths, numbers of segments, or material combinations to suit specific hose diameters or operational pressures. For example, the inner sleeve 111 may be non-braided for smoother internal flow, while the outer sleeve 112 is braided for external protection.

Features, structures, advantages, or characteristics described herein may be combined in any suitable manner across embodiments. The invention may be practiced without one or more specific features or advantages of a particular embodiment, and additional features or advantages may appear in some embodiments but not others.

Aspects of the invention may be embodied as systems, methods, apparatus, or processes, including hardware-only embodiments, software-only embodiments (e.g., firmware or executable instructions), or combinations thereof. Functional elements described as "modules," "circuits," or similar terms emphasize implementation independence and may be realized in hardware, software executing on processors, firmware, or suitable combinations.

While the instant disclosure has been described above according to one or more example embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

What is claimed:

1. A system, comprising:
a plurality of pipe segments configured for containing a high-pressure frac hose in hydraulic fracturing operations, each pipe segment including an inner flexible piping sleeve and an outer piping sleeve surrounding the inner flexible piping sleeve;
wherein the plurality of pipe segments are interconnectable to form an exoskeleton encasing the frac hose along its length, the exoskeleton securable between a pump truck providing a high pressure fluid source for the frac hose and a frame of a manifold or missile.

2. The system of claim 1, wherein the outer flexible piping sleeve is braided.

3. The system of claim 1, wherein at least one of the inner flexible piping sleeve and the outer piping sleeve is constructed from a material selected from the group consisting of T321 stainless steel, T304 stainless steel, Kevlar, braided nylon, braided rubber, and brass.

4. The system of claim 1, wherein each pipe segments further includes:
a pair of pipe flange ends at opposite termini of the outer piping sleeve, each pipe flange end having a plurality of spaced bolt holes;
a plurality of bolt, washer, and nut sets configured to secure facing pipe flange ends of adjacent pipe segments via the bolt holes;
at least one eyehook welded to at least one of the pipe flange ends, the eyehook forming a lifting eye; and
at least one anchoring shackle connectable to the lifting eye.

5. The system of claim 4, wherein each bolt, washer, and nut set comprises a grade 8 bolt torqued to at least 380 lb./ft, each grade 8 bolt having a tensile strength of at least 150,000 psi.

6. The system of claim 4, wherein each anchoring shackle has a working load limit of at least 4.75 tons and a maximum load of at least 28,500 psi.

7. The system of claim 4, further comprising:
at least one restraint cable attachable to the anchoring shackle, the at least one restraint cable configured to anchor the exoskeleton to fixed points such as the pump truck and the frame of the manifold or missile.

8. The system of claim 7, wherein each restraint cable is a wire whipcheck having a working load limit of at least 2.5 tons and a maximum load of at least 25,000 psi.

9. The system of claim 4, wherein the pipe flange ends are formed from schedule 40 carbon alloy steel having a tensile strength of at least 60,000 psi.

10. The system of claim 1, wherein the exoskeleton defines an annular pathway between the inner flexible piping sleeve and the frac hose for controlled discharge of fluid upon hose rupture.

11. The system of claim 1, wherein terminal pipe segments of the plurality of pipe segments are double-cabled with restraint cables.

12. A pipe segment, comprising:
an inner flexible piping sleeve configured to encase a portion of a frac hose; and
an outer piping sleeve surrounding the inner flexible piping sleeve;
wherein the pipe segment is configured for a modular hose restraint system in high-pressure fluid operations and is interconnectable with other like pipe segments to form an exoskeleton providing full-length containment of the frac hose.

13. The pipe segment of claim 12, wherein the outer piping sleeve is braided.

14. The pipe segment of claim 12, wherein at least one of the inner flexible piping sleeve and outer flexible piping sleeve is constructed from T321 stainless steel or T304 stainless steel.

15. The pipe segment of claim 12, wherein the exoskeleton defines an annular pathway between the inner flexible piping sleeve and the frac hose for controlled discharge of fluid upon hose rupture.

16. A method of containing a high-pressure frac hose using the system of claim 1, comprising:
sliding each pipe segment over a portion of the frac hose;
bolting adjacent pipe segments together to assemble the exoskeleton;
securing the assembled exoskeleton between a pump truck and a frame of a manifold or missile; and
operating the frac hose within the assembled exoskeleton.

17. The method of claim 16, further comprising replacing a damaged pipe segment by unbolting and removing it without disassembling the entire system.
